(19) United States
(12) Patent Application Publication
(10) Pub. No.: US 2013/0147873 A1
(43) Pub. Date: Jun. 13, 2013

(54) LIQUID EJECTING APPARATUS

(71) Applicant: SEIKO EPSON CORPORATION, Tokyo (JP)

(72) Inventors: Minoru KISHIGAMI, Shiojiri-shi (JP); Yoichi YAMADA, Shiojiri-shi (JP)

(73) Assignee: SEIKO EPSON CORPORATION, Tokyo (JP)

(21) Appl. No.: 13/706,778

(22) Filed: Dec. 6, 2012

(30) Foreign Application Priority Data
Dec. 8, 2011 (JP) 2011-268625

(51) Int. Cl. B41J 29/13; B41J 2/01

(52) U.S. Cl. CPC B41J 29/13; B41J 2/01
USPC 347/19

(57) ABSTRACT

Provided is a liquid ejecting apparatus that includes a liquid ejecting head that ejects ink as a liquid, a detection unit including a light emitting unit and a light receiving unit, and a transparent cover member that covers the detection unit. The cover member possesses the same charge polarity with respect to air as the charge polarity of ink mist which is mist generated from the ink ejected from the liquid ejecting head.

### BACKGROUND

1. Technical Field

The present invention relates to a liquid ejecting apparatus.

2. Related Art

Many of ink jet printers, typically exemplifying a liquid ejecting apparatus that ejects a liquid from a liquid ejecting head onto a recording medium such as a paper sheet transported along a supporting member so as to form an image, are configured to detect whether a paper sheet is present with a sensor unit including a light emitting element that emits light toward the supporting member and a photodetector that receives the light reflected by the paper sheet. If dust or the like is stuck to the sensor, the detection accuracy with respect to the paper sheet is degraded.

For example, JP-A-2005-254702 discloses a recording apparatus that includes a cover member provided so as to surround a sensor that detects whether a paper sheet is present, so that the cover member serves as an anti-dust wall that prevents paper powder from sticking to the sensor.

In the ink jet printer, however, ink mist is generated when an ink droplet is ejected from a liquid ejecting head. In addition, the ink droplet that has been ejected, as well as the ink mist generated therefrom, becomes electrically charged. Accordingly, the charged ink mist is prone to stick to the cover member accommodating therein the sensor, which leads to degradation in detection accuracy of the sensor with respect to the presence of the paper sheet.

### SUMMARY

The invention may be advantageously realized as the following application examples and embodiments.

### APPLICATION EXAMPLE 1

A first application example of the invention represents a liquid ejecting apparatus that includes a liquid ejecting head that ejects a liquid, a detection unit including a light emitting unit and a light receiving unit, and a transparent cover member that covers the detection unit. The cover member possesses the same charge polarity with respect to air as the charge polarity of mist generated from the liquid ejected from the liquid ejecting head.

In this application example, the cover member possesses the same charge polarity with respect to air as that of the mist generated from the liquid ejected from the liquid ejecting head. Accordingly, the cover member repels the mist. Such a configuration prevents the mist from sticking to the cover member covering the detection unit, thereby preventing degradation in detection accuracy of the detection unit.

### APPLICATION EXAMPLE 2

A second application example represents the liquid ejecting apparatus configured as above, in which the cover member possesses positive charge polarity with respect to air.

The liquid ejecting apparatus according to this application example is capable of repelling positively charged mist.

### APPLICATION EXAMPLE 3

A third application example represents the liquid ejecting apparatus configured as above, in which the cover member is formed of one of glass and nylon.

The configuration according to this application example allows the cover member to be positively charged with respect to air, and to thereby repel the positively charged mist.

### APPLICATION EXAMPLE 4

A fourth application example represents a liquid ejecting apparatus that includes a liquid ejecting head that ejects a liquid, and a detection unit including a light emitting unit, a light receiving unit, an emitter lens that covers the light emitting unit, and a receiver lens that covers the detection unit. The emitter lens and the receiver lens possess the same charge polarity with respect to air as the charge polarity of mist generated from the liquid ejected from the liquid ejecting head.

In this application example, the emitter lens and the receiver lens possess the same charge polarity with respect to air as that of the mist generated from the liquid ejected from the liquid ejecting head. Accordingly, the emitter lens and the receiver lens repel the mist. Such a configuration prevents the mist from sticking to the emitter lens and the receiver lens, thereby preventing degradation in detection accuracy of the detection unit.

### APPLICATION EXAMPLE 5

A fifth application example represents the liquid ejecting apparatus configured as above, in which the emitter lens and the receiver lens possess positive charge polarity with respect to air.

With the liquid ejecting apparatus according to this application example, the emitter lens and the receiver lens are capable of repelling positively charged mist.

### APPLICATION EXAMPLE 6

A sixth application example represents the liquid ejecting apparatus configured as above, in which the emitter lens and the receiver lens are formed of one of glass and nylon.

The configuration according to this application example allows the emitter lens and the receiver lens to be positively charged with respect to air and to thereby repel the positively charged mist.

### APPLICATION EXAMPLE 7

A seventh application example represents the liquid ejecting apparatus configured as above, further including a conductive nozzle plate attached to the liquid ejecting head and a conductive support member that supports a recording medium being transported, the support member being disposed so as to oppose the liquid ejecting head. The nozzle plate and the support member possess the same potential.

The configuration according to this application example suppresses generation of electric field between the nozzle plate and the support member, thereby facilitating the mist to be positively charged.

### APPLICATION EXAMPLE 8

An eighth application example represents the liquid ejecting apparatus configured as above, further including a conductive nozzle plate attached to the liquid ejecting head and a conductive support member that supports a recording medium being transported, the support member being disposed so as to oppose the liquid ejecting head. The support member is grounded.

The configuration according to this application example further facilitates the mist to be positively charged.

### APPLICATION EXAMPLE 9

A ninth the application example represents the liquid ejecting apparatus configured as above, further including a conductive nozzle plate attached to the liquid ejecting head and a conductive opposing member disposed so as to oppose the liquid ejecting head. The nozzle plate and the opposing member possess the same potential.

The configuration according to this application example suppresses generation of electric field between the nozzle plate and the opposing member, thereby facilitating the mist to be positively charged.

### APPLICATION EXAMPLE 10

A tenth application example represents the liquid ejecting apparatus configured as above, in which the opposing member is grounded.

The configuration according to this application example further facilitates the mist to be positively charged.

### APPLICATION EXAMPLE 11

An eleventh application example represents the liquid ejecting apparatus configured as above, in which the detection unit is configured to detect whether the recording medium is present.

The configuration according to this application example prevents degradation in detection accuracy with respect to the presence of the recording medium.

### APPLICATION EXAMPLE 12

A twelfth application example represents the liquid ejecting apparatus configured as above, further including a liquid container that stores therein a liquid. The detection unit is configured to detect whether the liquid is present.

The configuration according to this application example prevents degradation in detection accuracy with respect to the presence of the liquid stored in the liquid container.

### BRIEF DESCRIPTION OF THE DRAWINGS

The invention will be described with reference to the accompanying drawings, wherein like numbers reference like elements.

FIG. 1 is a schematic perspective view showing a liquid ejecting apparatus.

FIG. 2A is a schematic side view of a liquid ejecting head and a detection unit included in a carriage, and FIG. 2B is an enlarged view of a portion marked as IIB in FIG. 2A.

FIG. 3 is a schematic drawing showing ink being ejected from a liquid ejecting head onto a paper sheet.

FIGS. 4A and 4B are schematic drawings for explaining how ink mist is charged.

FIGS. 5A and 5B are schematic drawings each showing a liquid ejecting head and a support member according to an embodiment 2 and en embodiment 3, respectively.

FIG. 6 is a perspective view showing an ink cartridge according to an embodiment 4.

FIG. 7 is a schematic drawing showing an ink cartridge and a detection unit according to the embodiment 4.

### DESCRIPTION OF EXEMPLARY EMBODIMENTS

Hereafter, embodiments of the present invention will be described referring to the drawings.

### Embodiment 1

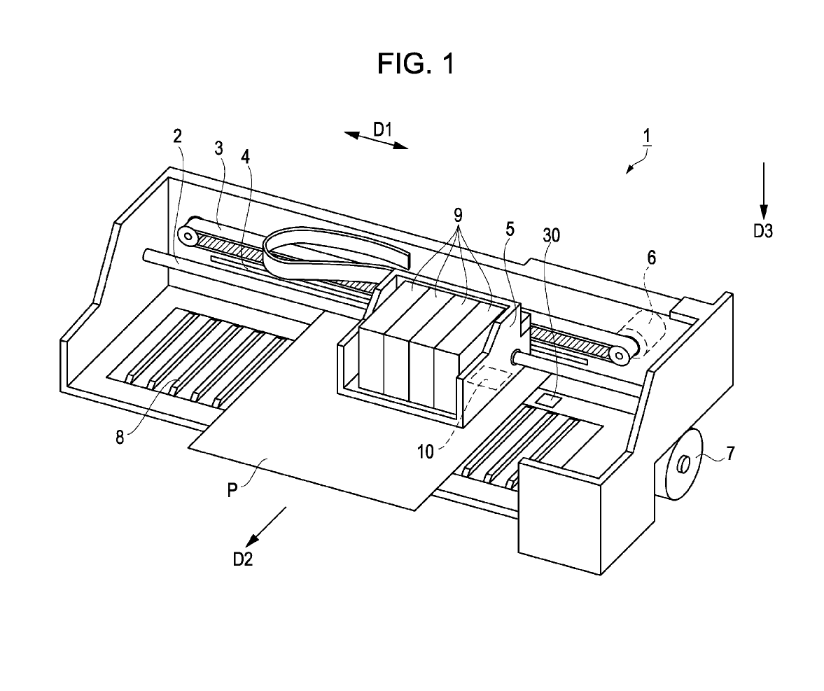

FIG. 1 is a schematic perspective view showing an ink jet printer (hereinafter, simply printer) 1, exemplifying the liquid ejecting apparatus, according to the embodiment 1.

A paper sheet P, exemplifying the recording medium, is pinched between a paper feed roller (not shown) driven to rotate by a paper feed motor 7 and a freely rotatable slave roller (not shown), and transported in transport direction D2 along a support member 8 that supports the paper sheet P.

The printer 1 includes a carriage 5 set to reciprocate in a stroke direction D1 intersecting the transport direction D2, guided along a guide shaft 2 by a timing belt 3 driven by a carriage motor 6.

The printer 1 also includes a linear scale 4 in which slits are formed at regular intervals in the stroke direction D1, and a linear encoder including an optical sensor (not shown) fixed to the carriage 5. The optical sensor detects the slit, to thereby detect the position of the carriage 5 in the stroke direction D1.

On the carriage 5, four ink cartridges 9 respectively containing ink of monochrome, yellow, magenta, and cyan, and exemplifying the liquid container, are removably mounted. A liquid ejecting head 10 that ejects the ink, exemplifying the liquid, is provided under the carriage 5 in a vertical direction D3.

A detection unit 30 that detects whether the ink is present in the ink cartridge 9 is provided upstream of the support member 8 in the transport direction D2, and under the ink cartridge 9 in the vertical direction D3.

The printer 1 causes the liquid ejecting head 10 to move and to eject the ink onto the paper sheet P being transported, so as to form an image on the paper sheet P.

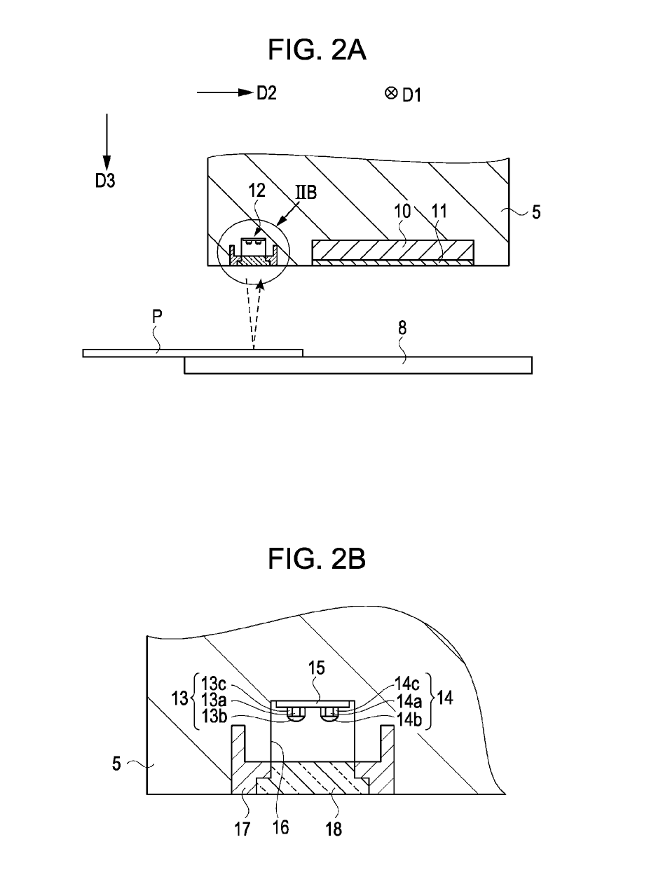

FIG. 2A schematically depicts the liquid ejecting head 10 and a detection unit 12 provided on the carriage 5, viewed in the stroke direction D1. The liquid ejecting head 10 having a nozzle plate 11 is located on a face of the carriage 5 opposing the support member 8.

The detection unit 12 is also located on the face of the carriage 5 opposing the support member 8. FIG. 2B is an enlarged view of a portion marked as IIB in FIG. 2A, in which the detection unit 12 is located. A light emitting unit 13, including a light emitting diode (LED) 13a, an emitter lens 13b, and a retention member 13c that retains the LED 13a and the emitter lens 13b, is provided on a circuit board 15.

In addition, a light receiving unit 14 including a phototransistor 14a, a receiver lens 14b, and a retention member 14c that retains the phototransistor 14a and the receiver lens 14b is provided on the circuit board 15. Thus, the light emitting unit 13, the light receiving unit 14, and the circuit board 15 constitute the detection unit 12.

The detection unit 12 is located inside a recess 16 formed in the carriage 5. A cover member 18 is provided so as to cover the detection unit 12, at the opening of the recess 16 opposing the support member 8. The cover member 18 is retained by a cover member holder 17.

The cover member 18 is formed of a light-transmissive glass. The cover member 18 may be formed of a light-transmissive nylon. With such a structure, the cover member 18 is located on the positive side in the triboelectric series, with respect to air.

When the light emitting unit 13 emits light toward the support member 8, the light passes through the cover member 18. The light reflected by the support member 8 or the paper sheet P again passes through the cover member 18 and is received by the light receiving unit 14. The detection unit 12 detects the presence of the paper sheet P transported along the support member 8, on the basis of the reflected light.

The detection unit 12 is placed in a closed space surrounded by the inner wall of the recess 16 and the cover member 18. Therefore ink mist is prevented from sticking to the light emitting unit 13 and the light receiving unit 14, and consequently degradation in detection accuracy can be prevented with respect to the presence of the paper sheet P.

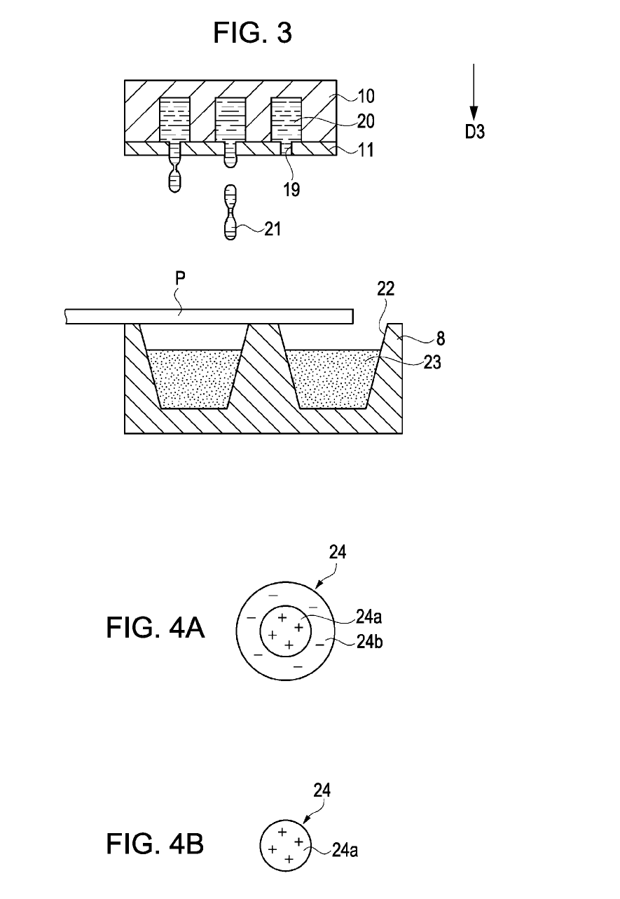

FIG. 3 is a schematic drawing showing the ink being ejected from the liquid ejecting head 10 onto the paper sheet P. The ink 20 in the liquid ejecting head 10 is ejected through nozzle orifices 19 formed in the nozzle plate 11, toward the paper sheet P supported by the support member 8.

The nozzle plate 11 and the support member 8 are formed of a conductive material, for example a metal such as a stainless steel or a conductive resin. In this embodiment, the nozzle plate 11 and the support member 8 are given a potential such that the potential of the nozzle plate 11 and that of the support member 8 becomes equal.

It is preferable employ a conductive material to form the support member 8, however the support member 8 may be formed of an insulative material and an absorbing material provided on the support member 8 may be formed of a conductive material.

An absorber 23, exemplifying the opposing member disposed opposite the liquid ejecting head 10, is provided in each of a plurality of grooves 22 formed on the support member 8. The absorber 23 contains a conductive material and, for example, is formed by foaming polyethylene or polyurethane in which a conductive material such as carbon is mixed. Alternatively, the absorber 23 may be formed by plating foamed polyethylene or foamed polyurethane with a conductive material. The absorber 23 is provided on the support member 8 such that electrical connection is secured therebetween.

Referring to FIG. 3, the ink 20 inside the liquid ejecting head 10 is ejected through the nozzle orifice 19 in a form of a liquid column 21. The ejected liquid column 21 is split, and a main portion of the liquid column 21 lands on the paper sheet P, while fine ink droplets land like satellites around the position where the main portion has landed.

FIGS. 4A and 4B are schematic drawings for explaining how the ink mist is charged. When the liquid column 21 is split into the main portion and the satellite-like ink droplets the ink mist is generated, which flows as an ink droplet 24 shown in FIG. 4A. The ink droplet 24 has a bilayer structure electrically. The core portion 24a of the ink droplet 24 is positively charged and the superficial portion 24b of the ink droplet 24 is negatively charged. The air in contact with the ink droplet 24 is positively charged.

When moisture on the surface of the ink droplet 24 evaporates with the negative charge, the positive charge is left on the ink droplet 24 as shown in FIG. 4B and resultantly the ink droplet 24 becomes positively charged (Lenard effect).

Thus, after the liquid ejecting head 10 ejects the ink 20, the positively charged ink mist floats in the air owing to the Lenard effect originating from the evaporation of moisture from the surface of the ink droplet 24. As the ink mist floats in the air for a longer time the evaporation of the moisture increases, and hence the ink mist becomes more positively charged.

The glass constituting the cover member 18 shown in FIG. 2B is positioned on the positive side in the friction triboelectric series, from paper or the like constituting the paper sheet P. Accordingly, the flow of the air causes friction with the cover member 18, so that the cover member 18 becomes positively charged.

In addition, in the printer 1 according to this embodiment, when the carriage 5 moves the cover member 18 causes friction with the air, which further facilitates the cover member 18 to be positively charged.

Since the ink mist and the cover member 18 are charged in the same polarity, i.e., both positively charged as described above, the ink mist and the cover member 18 repel each other. Therefore, the ink mist is prevented from sticking to the cover member 18. The ink mist repelled by the cover member 18 floats in the air, and is then absorbed by the absorber 23.

Thus, the printer 1 according to this embodiment includes the detection unit 12 having the light emitting unit 13 and the light receiving unit 14, the liquid ejecting head 10 that ejects the ink exemplifying the liquid, the transparent cover member 18 that covers the detection unit 12, and the conductive support member 8 that supports the paper sheet P exemplifying the recording medium to be transported, the support member 8 being disposed so as to oppose the liquid ejecting head 10, and the cover member 18 possesses the same charge polarity with respect to air as the polarity of the ink mist, which is the mist generated from the ink ejected from the liquid ejecting head 10.

In the printer 1 thus configured, the cover member 18 repels the ink mist. Such a configuration prevents the ink mist from sticking to the cover member 18 covering the detection unit 12, thereby preventing degradation in detection accuracy of the detection unit 12.

The cover member 18 is possesses the positive charge polarity with respect to air. Accordingly, the cover member 18 repels the mist which is positively charged.

In addition, the cover member 18 is formed of glass or nylon. Such a structure allows the cover member 18 to be positively charged with respect to air, and to thereby repel the positively charged mist.

Further, the nozzle plate 11 and the support member 8 possess the same potential in this embodiment. Such a configuration suppresses generation of electric field between the nozzle plate 11 and the support member 8, thereby facilitating the ink mist to be positively charged.

Further, the absorber 23 exemplifying the opposing member is electrically connected to the support member 8. Accordingly, the nozzle plate 11 of the liquid ejecting head 10 and the absorber 23 possess the same potential. Such a configuration suppresses generation of electric field between the nozzle plate 11 and the absorber 23, thereby further facilitating the ink mist to be positively charged.

### Embodiment 2

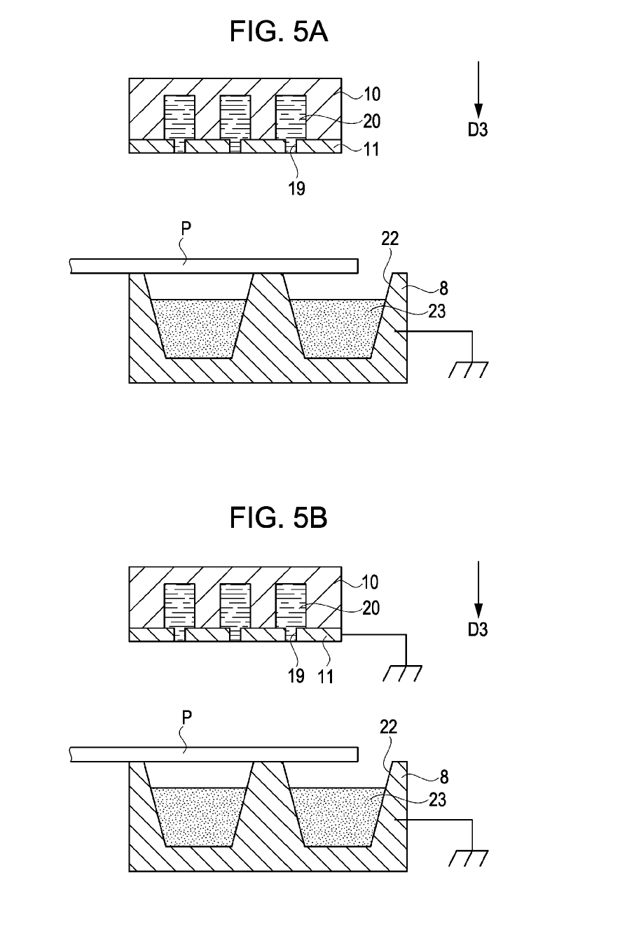

In an embodiment 2, the support member 8 is grounded. FIG. 5A is a schematic drawing showing the liquid ejecting head 10 and the support member 8 according to the embodiment 2.

The support member 8 is grounded in this embodiment, and hence the electric field between the nozzle plate 11 and the support member 8 has only small intensity. Therefore, the ink mist can readily be positively charged.

In addition, as in the embodiment 1, since the absorber 23 exemplifying the opposing member is electrically connected to the support member 8, the absorber 23 is also grounded via the support member 8. Accordingly, the electric field between the nozzle plate 11 and the absorber 23 has only small intensity, and therefore the ink mist can readily be positively charged. The configuration of the remaining portions according to this embodiment is the same as that of the embodiment 1.

### Embodiment 3

In an embodiment 3, the support member 8 and the nozzle plate 11 are both grounded. FIG. 5B is a schematic drawing showing the liquid ejecting head 10 and the support member 8 according to the embodiment 3.

Both of the support member 8 and the nozzle plate 11 are grounded in this embodiment. Such a configuration suppresses generation of electric field between the nozzle plate 11 and the support member 8, thereby further facilitating the ink mist to be positively charged.

In addition, as in the embodiment 1, since the absorber 23 exemplifying the opposing member is electrically connected to the support member 8, the absorber 23 is also grounded via the support member 8. Accordingly, generation of electric field is suppressed between the nozzle plate 11 and the absorber 23, which even further facilitates the ink mist to be positively charged. The configuration of the remaining portions according to this embodiment is the same as that of the embodiment 1.

### Embodiment 4

In the embodiments 1 to 3, the detection unit 12 is configured so as to detect whether the paper sheet P is present. In contrast, a detection unit according to an embodiment 4 is configured to detect whether the ink is present in the ink cartridge 9.

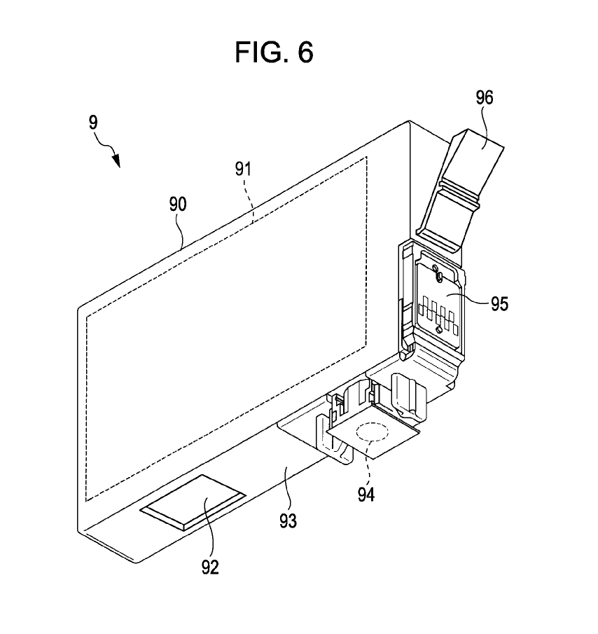

FIG. 6 is a perspective view showing the ink cartridge 9 according to this embodiment. The ink cartridge 9 exemplifying the liquid container includes a generally rectangular block-shaped ink storage portion 90 in which the ink is stored, a substrate 95 on which a memory for storing therein information about the ink cartridge 9 is mounted, and a lever 96 used to remove and attach the ink cartridge 9 from and to the carriage 5.

An ink supply port 94, to which an ink supply needle (not shown) provided in the carriage 5 is inserted upon attaching the ink cartridge 9 is attached to the carriage 5, is provided on a bottom face 93 of the ink cartridge 9. Before the ink cartridge 9 is used, the opening of the ink supply port 94 is covered with a film.

The ink storage portion 90 includes an ink chamber 91 in which the ink is accommodated. In addition, as shown in FIG. 6, a prism 92 of an isosceles right triangle column shape is provided inside the ink chamber 91 and on the side of the support member 8. More specifically, the prism 92 is located in the bottom face 93 of the ink cartridge 9. Upon attaching the ink cartridges 9 thus configured to the carriage 5 from a position opposite the support member 8, the ink becomes able to be supplied from the ink cartridge 9 to the liquid ejecting head 10.

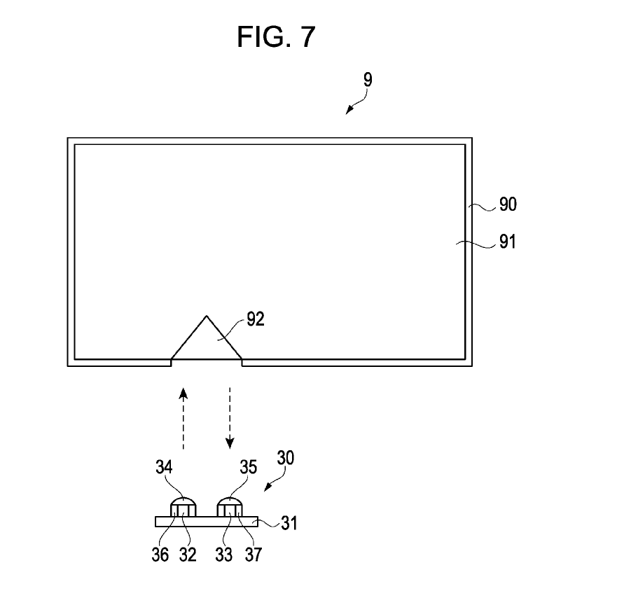

FIG. 7 is a schematic drawing showing the ink cartridge 9 and the detection unit 30 according to this embodiment. The detection unit 30 is located at a position corresponding to the prism 92 of the ink cartridge 9 in the transport direction D2.

A light emitting unit 32 composed of an LED or the like and a light receiving unit 33 composed of a phototransistor or the like are mounted on a circuit board 31. A portion of the light emitting unit 32 opposing the ink cartridge 9 is covered with an emitter lens 34. A portion of the light receiving unit 33 opposing the ink cartridge 9 is covered with a receiver lens 35.

The light emitting unit 32 and the emitter lens 34 are retained by a retention member 36 provided on the circuit board 31. The light receiving unit 33 and the receiver lens 35 are retained by a retention member 37 provided on the circuit board 31. Thus, the circuit board 31, the light emitting unit 32, the light receiving unit 33, the emitter lens 34, the receiver lens 35, and the retention members 36, 37 constitute the detection unit 30.

When the carriage 5 is moved in the stroke direction D1, the prism 92 comes to the position opposite the detection unit 30. Light emitted from the light emitting unit 32 passes through the emitter lens 34 and the prism 92, and then the light reflected in the ink chamber 91 again passes through the prism 92 and the receiver lens 35, thus to be received by the light receiving unit 33.

Accordingly, the detection unit 30 can detect whether the ink is present in the ink chamber 91 of the ink cartridge 9, on the basis of the reflected light.

As described above, the printer according to this embodiment includes the detection unit 30 having the light emitting unit 32, the light receiving unit 33, the emitter lens 34 covering the light emitting unit 32, and the receiver lens 35 covering the light receiving unit 33, the liquid ejecting head 10 that eject the ink, and the support member 8 opposing the liquid ejecting head 10 and serving to support the paper sheet P, and the emitter lens 34 and the receiver lens 35 possess the same charge polarity with respect to air as the charge polarity of the ink mist generated from the ink ejected from the liquid ejecting head 10.

Therefore, the emitter lens 34 and the receiver lens 35 repel the ink mist. Such a configuration prevents the ink mist from sticking to the emitter lens 34 covering the light emitting unit 32 and the receiver lens 35 covering the light receiving unit 33, thereby preventing degradation in detection accuracy of the detection unit 30.

In addition, the emitter lens 34 and the receiver lens 35 both possess the positive charge polarity with respect to air. Such a configuration allows the emitter lens 34 and the receiver lens 35 to repel the ink mist which is positively charged.

Further, the emitter lens 34 and the receiver lens 35 are formed of glass or nylon. Therefore, the emitter lens 34 and the receiver lens 35 are positively charged with respect to air, and are hence capable of repelling the positively charged mist.

Although the foregoing embodiments 1 to 4 represent the printer 1 that includes the liquid ejecting head 10 mounted on the carriage 5 set to reciprocate in the direction intersecting the transport direction D2, the invention is also applicable to a liquid ejecting apparatus configured to eject ink through nozzles formed on a fixed liquid ejecting head and aligned in a direction intersecting the transport direction D2 of the paper sheet P, so as to form an image.

The entire disclosure of Japanese Patent Application No. 2011-268625, filed Dec. 8, 2011 is expressly incorporated by reference herein.

What is claimed is:

1. A liquid ejecting apparatus comprising:
a liquid ejecting head that ejects a liquid;
a detection unit including a light emitting unit and a light receiving unit; and
a transparent cover member that covers the detection unit,
wherein the cover member possesses the same charge polarity with respect to air as the charge polarity of mist generated from the liquid ejected from the liquid ejecting head.

2. The liquid ejecting apparatus according to claim 1,
wherein the cover member possesses positive charge polarity with respect to air.

3. The liquid ejecting apparatus according to claim 2,
wherein the cover member is formed of one of glass and nylon.

4. The liquid ejecting apparatus according to claim 1, further comprising a conductive nozzle plate attached to the liquid ejecting head and a conductive support member that supports a recording medium being transported thereon, the support member being disposed so as to oppose the liquid ejecting head,
wherein the nozzle plate and the support member possess the same potential.

5. The liquid ejecting apparatus according to claim 1, further comprising a conductive nozzle plate attached to the liquid ejecting head and a conductive support member that supports a recording medium being transported thereon, the support member being disposed so as to oppose the liquid ejecting head,
wherein the support member is grounded.

6. The liquid ejecting apparatus according to claim 1, further comprising a conductive nozzle plate attached to the liquid ejecting head and a conductive opposing member disposed so as to oppose the liquid ejecting head,
wherein the nozzle plate and the opposing member possess the same potential.

7. The liquid ejecting apparatus according to claim 1,
wherein the opposing member is grounded.

8. The liquid ejecting apparatus according to claim 1,
wherein the detection unit is configured to detect whether the recording medium is present.

9. The liquid ejecting apparatus according to claim 1, further comprising a liquid container that stores therein the liquid,
wherein the detection unit is configured to detect whether the liquid is present.

10. A liquid ejecting apparatus comprising:
a liquid ejecting head that ejects a liquid; and
a detection unit including a light emitting unit, a light receiving unit, an emitter lens that covers the light emitting unit, and a receiver lens that covers the light receiving unit,
wherein the emitter lens and the receiver lens possess the same charge polarity with respect to air as the charge polarity of mist generated from the liquid ejected from the liquid ejecting head.

11. The liquid ejecting apparatus according to claim 10,
wherein the emitter lens and the receiver lens possess positive charge polarity with respect to air.

12. The liquid ejecting apparatus according to claim 10,
wherein the emitter lens and the receiver lens are formed of one of glass and nylon.

13. The liquid ejecting apparatus according to claim 10, further comprising a conductive nozzle plate attached to the liquid ejecting head and a conductive support member that supports a recording medium being transported thereon, the support member being disposed so as to oppose the liquid ejecting head,
wherein the nozzle plate and the support member possess the same potential.

14. The liquid ejecting apparatus according to claim 10, further comprising a conductive nozzle plate attached to the liquid ejecting head and a conductive support member that supports a recording medium being transported thereon, the support member being disposed so as to oppose the liquid ejecting head,
wherein the support member is grounded.

15. The liquid ejecting apparatus according to claim 10, further comprising a conductive nozzle plate attached to the liquid ejecting head and a conductive opposing member disposed so as to oppose the liquid ejecting head,
wherein the nozzle plate and the opposing member possess the same potential.

16. The liquid ejecting apparatus according to claim 10,
wherein the opposing member is grounded.

17. The liquid ejecting apparatus according to claim 10,
wherein the detection unit is configured to detect whether the recording medium is present.

18. The liquid ejecting apparatus according to claim 10, further comprising a liquid container that stores therein the liquid,
wherein the detection unit is configured to detect whether the liquid is present.
